(19) United States
(12) Patent Application Publication
(10) Pub. No.: US 2017/0111272 A1
(43) Pub. Date: Apr. 20, 2017

(54) Determining Direction of Network Sessions

(71) Applicant: vArmour Networks, Inc., Mountain View, CA (US)

(72) Inventors: Zhiping Liu, Saratoga, CA (US); Choung-Yaw Shieh, Palo Alto, CA (US); Meng Xu, Los Altos, CA (US)

(21) Appl. No.: 14/883,447

(22) Filed: Oct. 14, 2015

(51) Int. Cl. H04L 12/741; H04L 29/06

(52) U.S. Cl. CPC H04L 45/74; H04L 69/22

(57) ABSTRACT

Systems and methods for determining a direction of a network session are described herein. An example method may commence with receiving a data packet by a network device. The method may continue with analyzing contextual data associated with the data packet. Based on the analysis, the direction of the network session may be determined. Upon determining of the network session, the data packet may be directed according to the direction of the network session. The analysis may include determining that the data packet is associated with a previous network session. Based on the determination, the data packet may be attributed to the previous network session.

### TECHNICAL FIELD

The present disclosure relates generally to data processing and, more specifically, to methods and systems for determining a direction of a network session in distributed and non-distributed networks.

### BACKGROUND

The approaches described in this section could be pursued but are not necessarily approaches that have previously been conceived or pursued. Therefore, unless otherwise indicated, it should not be assumed that any of the approaches described in this section qualify as prior art merely by virtue of their inclusion in this section.

A network session is an interactive information interchange that occurs between two or more communication devices in a network, such as a client and a server, and lasts for a certain time. Conventionally, a network device, such as a routing device or a network security device, may be located within the network between the client and the server. The network device may receive a first data packet of the network session and determine a source Internet Protocol (IP) address and/or a destination IP address. Typically, based on the source IP address and/or a destination IP address, the network device may determine whether the network session is initiated by the client (i.e., the first data packet has a client-to-server direction) or by the server (i.e., the first data packet has a server-to-client direction).

Under certain conditions, for example, upon occurrence of a data packet re-order, data packet duplication, or data packet loss, the first data packet received by the network device may not be actually the first data packet of the network session. Therefore, based on network session information contained in the data packet received first, the network device may incorrectly determine a direction of the network session or establish a new network session instead of associating the data packet with a previous network session.

Additionally, the network device may drop a current network session in case of an idle timeout when no data packets are received for the current network session for a specified period. However, an idle timeout period for the network session of the network device may be smaller than an idle timeout period of the client or the server. Therefore, if no data packets are received during the idle timeout period (e.g., when data packets of the network session are lost), the network device may determine that the current network session was terminated and create a new network session for data packets received after the idle timeout period of the network device. Therefore, multiple network sessions may be created by the network device.

Additionally, the network device may incorrectly identify whether the data packet is sent by the client or the server and, therefore, the direction determined by the network device for the newly created network session may be incorrect. Furthermore, network session information incorrectly determined by the network device and incorrect data packet association can lead to issues in network policy enforcement and network security analytics.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Provided are systems and methods for determining a direction of a network session. An example system for determining a direction of a network session may comprise a network device and an analyzing unit. The network device may be operable to receive a data packet. Upon receipt of the data packet by the network device, the analyzing unit may analyze contextual data associated with the data packet. Based on the analysis, the analyzing unit may be operable to determine the direction of the network session associated with the data packet. The network device may be operable to direct the data packet according to the direction of the network session.

An example method for determining a direction of a network session may commence with receiving a data packet by a network device. The method may continue with analyzing contextual data associated with the data packet. Based on the analysis, the direction of the network session may be determined. Upon determining of the direction of the network session, the data packet may be directed according to the determined direction. The analysis may include determining that the data packet is associated with a previous network session. Based on the determination, the data packet may be attributed to the previous network session.

In further exemplary embodiments, modules, subsystems, or devices can be adapted to perform the recited steps. Other features and exemplary embodiments are described below.

### BRIEF DESCRIPTION OF THE DRAWINGS

Embodiments are illustrated by way of example and not limitation in the figures of the accompanying drawings, in which like references indicate similar elements.

FIG. 1 illustrates an environment within which systems and methods for determining a direction of a network session can be implemented, in accordance with some embodiments.

FIG. 2 is a flow chart illustrating a method for determining a direction of a network session, in accordance with some example embodiments.

FIG. 3 is a block diagram showing various modules of a system for determining a direction of a network session, in accordance with certain embodiments.

FIG. 4 shows a flow diagram of determining a direction of a network session, in accordance with an example embodiment.

FIG. 5 shows a diagrammatic representation of a computing device for a machine in the exemplary electronic form of a computer system, within which a set of instructions for causing the machine to perform any one or more of the methodologies discussed herein, can be executed.

### DETAILED DESCRIPTION

The following detailed description includes references to the accompanying drawings, which form a part of the detailed description. The drawings show illustrations in accordance with exemplary embodiments. These exemplary embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents. In this document, the terms “a” and “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

This disclosure provides methods and systems for determining a direction of a network session. Because loss, re-order, or duplication of data packets may cause incorrect identification of a source and a destination of the data packets, the methods and systems discussed herein may allow making a decision as to whether the data packet relates to a new network session or is associated with one of the previous network sessions. More specifically, a network security device, also referred to herein as a network device, may monitor a network for malicious activity. The network security device may work in an inline mode or a tap mode. In the inline mode, the network security device may be placed directly in the data traffic path and may inspect all data traffic as it passes through the network security device. Therefore, data packet inspection can be performed in real time to allow addressing intrusive data packets immediately and dropping malicious data packets. In the tap mode, the network security device can receive and monitor a copy of every data packet and can warn of an attack but cannot block malicious data packets.

Loss of data packets may be important to both the inline mode and the tap mode. In the inline mode, the network security device may use further data packets to identify that a direction of the data packets and, therefore, the direction of the network session, was identified incorrectly and to fix the direction. However, in the tap mode, the network security device works only with a copy of the data packet and is unable to fix the direction of the data packet itself. Therefore, incorrect determination of the direction of the data packet and, therefore, the direction of the network session, may be important in the tap mode.

According to methods and systems of the present disclosure, a network device is operable to analyze contextual data of a received data packet to identify a client-to-server direction or a server-to-client direction of a network session. Conventionally, the network device defines the network session by considering 5-tuple filters, namely: a source IP address, a destination IP address, a source port, a destination port, and a protocol type. One of the tasks of the network device may include correct identification of each parameter of the filters. For this purpose, the network device may be provided with a set of attributes associated with the client-to-server direction or the server-to-client direction of the network session. If the network device inspects the data packet and identifies an attribute that is peculiar to the client-to-server direction, for example, to a session initiation request of the client, the network device may define a device from which the data packet is received to be a source device (a client) and a device to which the data packet is forwarded to be a destination device (a server). Furthermore, if the network device identifies an attribute that is peculiar to the server-to-client direction, for example, to a server response to the client, the network device may define a device from which the data packet is received to be the destination device (the server) and a device to which the data packet is forwarded to be the source device (the client). Therefore, even if the inspected data packet is a first data packet received by the network device but not the first data packet of the network session (e.g., when first data packets are lost), the network device may correctly identify source and destination data (such as a source IP address, a destination IP address, a source port, and a destination port) of the data packet in the network session.

The network device of the present disclosure may operate in a distributed network and a non-distributed network. A distributed network is a type of computer network, in which enterprise infrastructure resources are divided over a number of networks, processors, and intermediary devices. Therefore, in some example embodiments, the network device may operate as a single device in the non-distributed network. In other embodiments, the functionality of the network device described herein may be spread out over a plurality of virtual machines inside the distributed network.

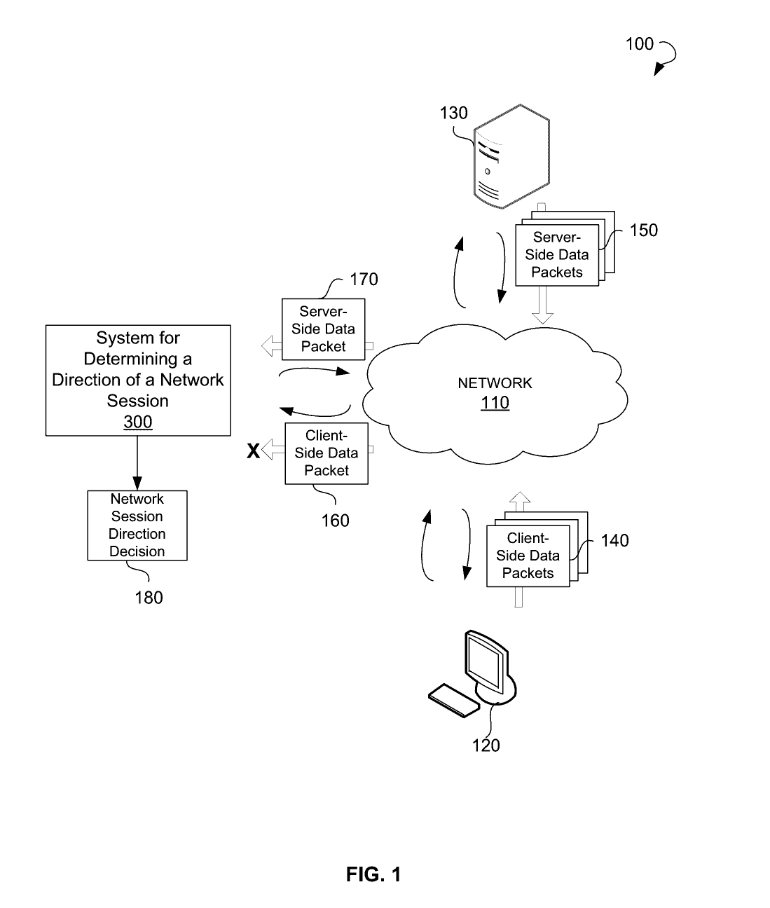

FIG. 1 illustrates an environment 100 within which systems and methods for determining a direction of a network session can be implemented, in accordance with some embodiments. The environment 100 may include a network 110, a client 120, a server 130, and a system 300 for determining a direction of a network session. The client 120 may include a network machine or a network resource that sends client-side data packets 140 to the server 130. The server 130, in turn, may send server-side data packets 150 to the client 120. By exchanging the client-side data packets 140 and server-side data packets 150, the client 120 and the server 130 may establish a network session. The client 120 and the server 130 may communicate with each other using the network 110.

The network 110 may include the Internet or any other network capable of communicating data between devices. Suitable networks may include or interface with any one or more of, for instance, a local intranet, a Personal Area Network, a Local Area Network, a Wide Area Network, a Metropolitan Area Network, a virtual private network, a storage area network, a frame relay connection, an Advanced Intelligent Network connection, a synchronous optical network connection, a digital T1, T3, E1 or E3 line, Digital Data Service connection, Digital Subscriber Line connection, an Ethernet connection, an Integrated Services Digital Network line, a dial-up port such as a V.90, V.34 or V.34b is analog modem connection, a cable modem, an Asynchronous Transfer Mode connection, or a Fiber Distributed Data Interface or Copper Distributed Data Interface connection. Furthermore, communications may also include links to any of a variety of wireless networks, including Wireless Application Protocol, General Packet Radio Service, Global System for Mobile Communication, Code Division Multiple Access or Time Division Multiple Access, cellular phone networks, Global Positioning System, cellular digital packet data, Research in Motion, Limited duplex paging network, Bluetooth radio, or an IEEE 802.11-based radio frequency network. The network 110 can further include or interface with any one or more of an RS-232 serial connection, an IEEE-1394 (FireWire) connection, a Fiber Channel connection, an infrared port, a Small Computer Systems Interface connection, a Universal Serial Bus connection or other wired or wireless, digital or analog interface or connection, mesh or Digi® networking. The network 110 may include a network of data processing nodes that are interconnected for the purpose of data communication.

During the network session, one of the data packets shown as a client-side data packet 160 may be lost. Therefore, the system 300 may be unable to receive the client-side data packet 160. Instead, the system 300 may receive a server-side data packet 170, which can be a server response to the client-side data packet 160. By analyzing data associated with the server-side data packet 170, the system 300 may make a network session direction decision 180 as to whether the server-side data packet 170 relates to the established network session or is a data packet of a new network session.

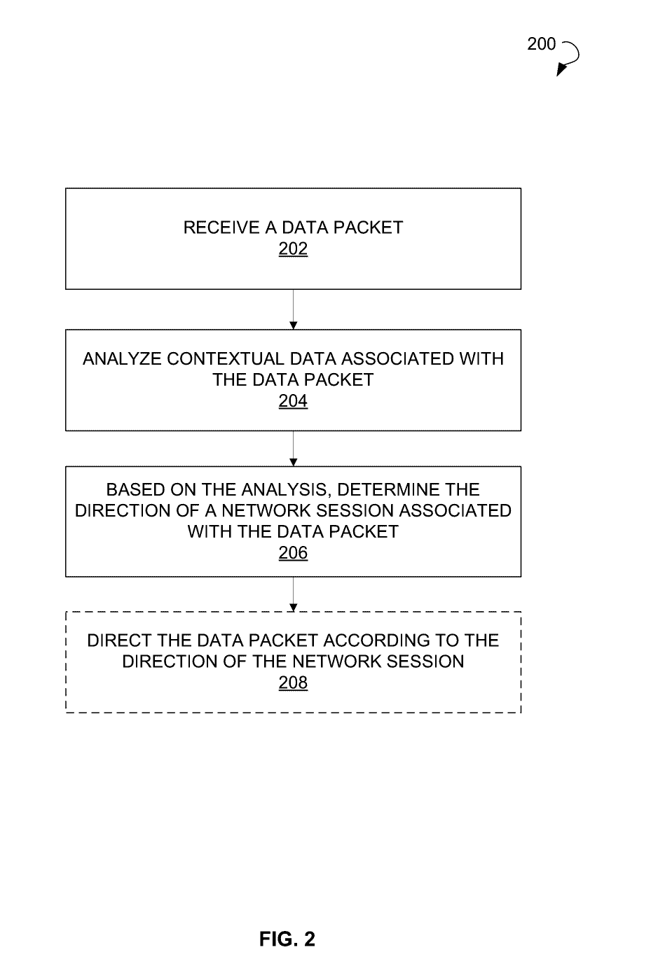

FIG. 2 is a flow chart illustrating a method 200 for determining a direction of a network session, in accordance with some example embodiments. The method 200 may commence with receiving a data packet by a network device at operation 202. At operation 204, the network device may analyze contextual data associated with the data packet.

A data packet may consist of control information and a payload. The control information may include data for delivering the payload (for example, source and destination network addresses, error detection codes, sequencing information, and so forth). Typically, control information may be located in a header and a trailer of the data packet. The header refers to supplemental data placed at the beginning of the data packet. The trailer refers to supplemental data placed in the data packet, which may contain information for handling of the data packet, or may mark the end of the data packet. The data that follows the end of the header and precedes the start of the trailer is the payload. The payload may include the data that is carried within the data packet on behalf of an application. In an example embodiment, the application may include an application executing on a client or an application executing on a server, which can communicate with other applications executing on other devices of the network. To send and receive data packets, the application may use different application layer protocols, such as HyperText Transfer Protocol (HTTP), File Transfer Protocol, and so forth, and different message formats, such as Extensible Markup Language, Electronic Data Interchange, and so forth. Internet protocols that implement network sessions may include Transmission Control Protocol (TCP), User Datagram Protocol (UDP), Internet Control Message Protocol (ICMP), and so forth.

Therefore, in an example embodiment, the contextual data analyzed by the network device may include payload data, header data, or trailer data of the data packet. Furthermore, the contextual data may include data associated with previous network sessions.

At operation 206, based on the analysis of the contextual data, the network device may determine the direction of the data packet. The direction of the data packet may correspond to the direction of the network session. The determining of the direction may include determining whether the data packet is directed from a client to a server or from the server to the client. More specifically, the determining of the direction may include determining a source and a destination of the data packet, such as a source IP address, a destination IP address, a source port, and a destination port.

Based on the analysis of the contextual data, the network device may determine that the data packet is not associated with a previous network session between the client and the server. Upon such determination, the network device may create a new network session using metadata (e.g., the source IP address and the destination IP address) associated with the data packet.

In a further example embodiment, based on the analysis of the contextual data, the network device may determine that the data packet is associated with a previous network session. Upon such determination, the network device may attribute the data packet to the previous network session.

Upon determining of the direction of the data packet, the network device may direct the data packet according to the determined direction of the data packet at optional operation 208.

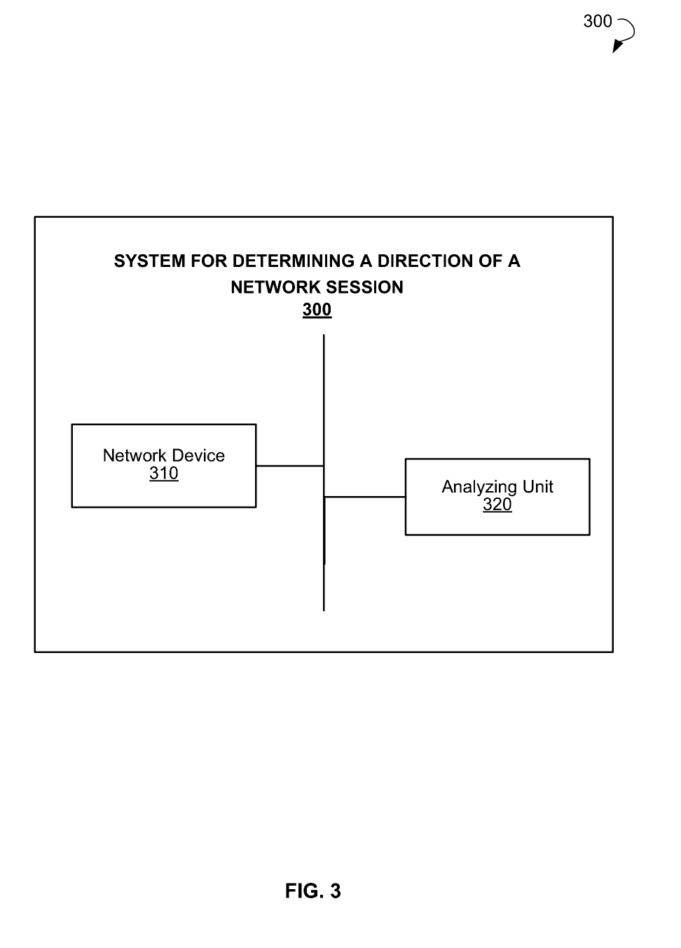

FIG. 3 is a block diagram showing various modules of a system 300 for determining a direction of a network session, in accordance with certain embodiments. The system may comprise a network device 310 and an analyzing unit 320. In an example embodiment, the network device 310 may include a firewall, an intrusion detection device, and any session-based security device disposed in a data traffic path between a client and a server. In a further example embodiment, the analyzing unit 320 may be an integral part of the network device 310. Therefore, all functions performed by the analyzing unit 320 may be considered to be performed by the network device 310.

The network device 310 may be operable to receive a data packet. The analyzing unit 320 may be operable to analyze contextual data associated with the data packet. The contextual data may include payload data, header data, trailer data of the data packet, and so forth. In an example embodiment, the contextual data may be associated with previous network sessions.

Based on the analysis, the analyzing unit 320 may be operable to determine the direction of the data packet. The direction of the data packet may be associated with the direction of the network session, more specifically, the direction of the data packet may correspond to the direction of the network session. The determining of the direction may include determining a source and a destination of the data packet. The direction of the data packet may include a direction between a client and a server.

In an example embodiment, the analyzing unit 320 may be operable to determine that the data packet is associated with a previous network session. Based on the determination, the analyzing unit 320 may be operable to attribute the data packet to the previous network session. In a further example embodiment, the analyzing unit 320 may be operable to determine that the data packet is not associated with a previous network session. Based on such determination, the analyzing unit 320 may be operable to create a new network session using metadata associated with the data packet.

Upon determining of the direction of the data packet, the network device 310 may be operable to direct the data packet according to the determined direction of the data packet.

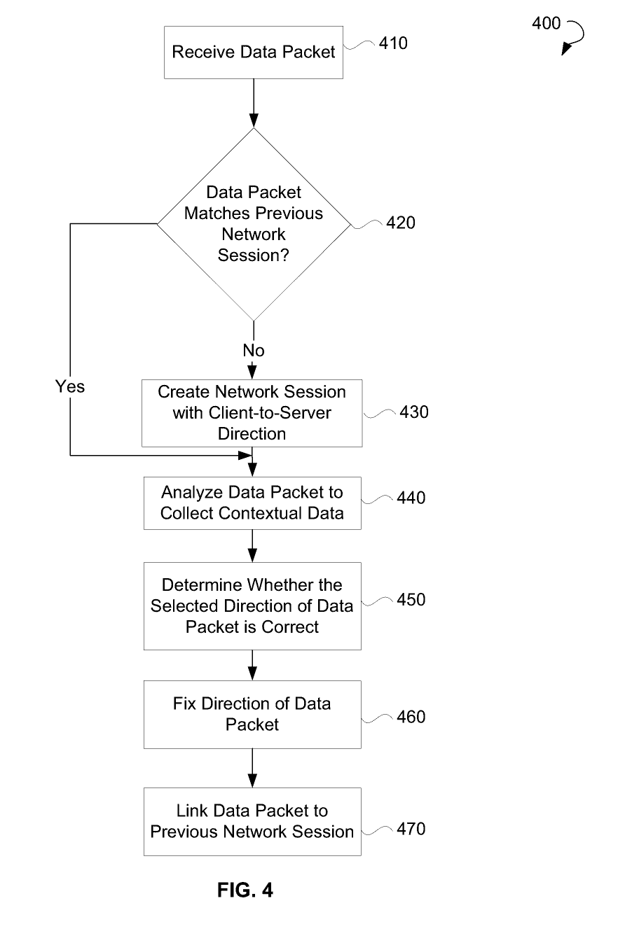

FIG. 4 shows a block diagram 400 of determining a direction of a network session, according to an example embodiment. At block 410, a network device may receive a data packet. At block 420, the network device may determine whether the data packet matches a previous network session. For example, if metadata of the data packet is associated with data of the previous network session, block 440 may be further implemented. If the metadata data of the data packet does not relate to a previous network session, a new network session may be created at block 430. The new network session may be created based on the following parameters indicated in the data packet: a source IP address, a destination IP address, a source port, a destination port, and a protocol type.

In an example embodiment, the network device selects a client-to-server direction for the data packet and, therefore, for the network session. At block 440, the network device may analyze the data packet to collect the contextual data associated with the data packet. The analysis may include collecting data from an Ethernet field or a protocol field of the data packet. The protocol field may include IP field, TCP field, UDP field, ICMP field, or other IP protocol field. Additionally, the analysis may include analyzing an application context, namely collecting the contextual data from the payload of the data packet. In an example embodiment, the contextual data from the payload may include data peculiar to a network session establishment request of a client, a response of a server to the client, and so forth. For example, in an HTTP network session, the response of the server may typically start with an ‘HTTP/1.0’ code. Upon finding such code, the network device may determine that the data packet associated with this code is directed from the server to the client.

At block 450, the network device may determine, based on the collected contextual data, whether the selected direction for the data packet and, therefore, for the network session is correct. At block 460, if the direction selected for the network session created at block 430 is incorrect, the network device may fix the direction by changing the client-to-server to the server-to-client direction of the data packet and network session. Additionally, at block 470, upon fixing of the direction of the data packet, the network device may associate the new network session with the previous network session. Therefore, the new network session may be linked to the previous network session and the data packet linked to the previous network session.

### EXAMPLE 1

### TCP Data Packet Analysis

A network session may be implemented using a TCP. A TCP network session may include a data packet with a ‘SYN’ (synchronize) flag sent from a network address of a client to a network address of a server and a data packet with a ‘SYN-ACK’ (synchronize-acknowledgement) flag sent from the network address of the server to the network address of the client in response to receiving the data packet with the ‘SYN’ flag from the client.

In an example embodiment, the data packet with the ‘SYN’ flag may be lost and the network device may receive only the data packet with the ‘SYN-ACK’ flag. Upon receipt of the data packet with the ‘SYN-ACK’ flag, the network device may conventionally create a network session with the network address of the server as a source network address and the network address of the client as a destination network address. However, such direction of data packets in the created network session may be incorrect as, in fact, the network address of the client is the source network address and the network address of the server is the destination network address.

To determine the correct direction of data packets sent between the client and the server, the network device may determine the data packet with the ‘SYN-ACK’ flag to be the data packet sent from the destination network address to the source network address in response to a network session establishment request (i.e., the data packet with the ‘SYN’ flag). Therefore, the network device may determine the correct direction of the network session to be the direction from the client to the server. The network address of the client may be determined to be the source network address and the network address of the server may be determined to be the destination network address.

ICMP data packet and UDP data packet analysis. Similarly, in case of an ICMP network session or a UDP network session, the network device may analyze the data packet to find specific codes. More specifically, the network device may associate some specific codes in the data packet to be response codes. Therefore, in the case of finding the response code, the network device may determine the direction of the network session to be from the server to the client.

### EXAMPLE 2

### Domain Name System (DNS) Response Analysis

The DNS network session may include a DNS request data packet sent from the network address of the client to the network address of the server and a DNS response data packet sent from the network address of the server to the network address of the client. When the network device receives only the DNS response data packet, the network device may conventionally create a network session with the network address of the server as a source network address and the network address of the client as a destination network address (namely, the server-to-client direction).

To determine the correct direction of the DNS network session between the client and the server, the network device may analyze the DNS response data packet and identify the DNS response data packet to be the response of the server sent to the client. Therefore, the network device may determine the direction to be from the client to the server. The network address of the client may be determined to be the source network address and the network address of the server may be determined to be the destination network address.

### EXAMPLE 3

### TCP Reset Network Session Analysis

The TCP network session may include a data packet with an ‘RST’ (reset) flag to reset the connection. Upon receiving of the data packet with the ‘RST’ flag, the network device may conventionally create a network session with the network address of the server as a source network address and the network address of the client as a destination network address (namely, the server-to-client direction).

To determine the correct direction of the TCP network session between the client and the server, the network device may analyze data associated with previous network sessions. The network device may determine whether there is a previous network session in which the source network address of the client matches a client port indicated in the data packet with the ‘RST’ flag and the destination network address of the server matches a server port indicated in the data packet with the ‘RST’ flag. If a match is detected, the network device may consider the data packet with the ‘RST’ flag to be associated with the previous network session. Therefore, the network device may determine the correct direction as the direction from the client network address to the server network address.

### EXAMPLE 4

### Multiple Network Session Creation Due to Network Session Timeout Settings of a Network Device

During a TCP network session between a client and a server, the client and the server may exchange data packets for a certain time, be idle for a certain time, and then exchange further data packets. If the longest time between sending of two sequential data packets is longer than a network session timeout setting in the network device, the network device may determine that the network session was ended and delete data associated with the network session from history data. Therefore, the network session may create a new network session upon receipt of a further data packet. In case of several idle periods in communication between the client and the server, multiple new network sessions may be created. However, multiple network sessions with the same source network addresses or the same destination network addresses may be considered as a Denial of Service (DoS) attack. In case of determining the data packets to be the DoS attack, the network device may identify the client or the server as an attacker and block all further data packets from the source network address to the destination network address or from the destination network address to the source network address. Additionally, the network device may incorrectly identify whether the direction of the further data packet is from the client to the server or from the server to the client.

To determine the correct direction of the network session between the client and the server, the network device may analyze data associated with previous network sessions to determine if the data packet matches the 5-tuple filter, the reverse 5-tuple filter for the network session, or other network session properties (e.g., parent/child network session, session close reason, and so forth). If a match is determined, the network device may determine the current network session to be a continuation of the previous network session. The network device may link the current network session to the previous network session for correct processing of further data packets.

Additionally, the network device may store data associated with network sessions in a permanent storage for a specific time to be able to find data associated with any previous network sessions. Additionally, the network device may alert a network operator about the necessity to change network settings associated with the network device. More specifically, the network device may inform the network operator that the idle timeout setting of the network device needs to be changed, for example, for a specific client or a specific server, to eliminate further improper dropping of network sessions between the specific client and the specific server.

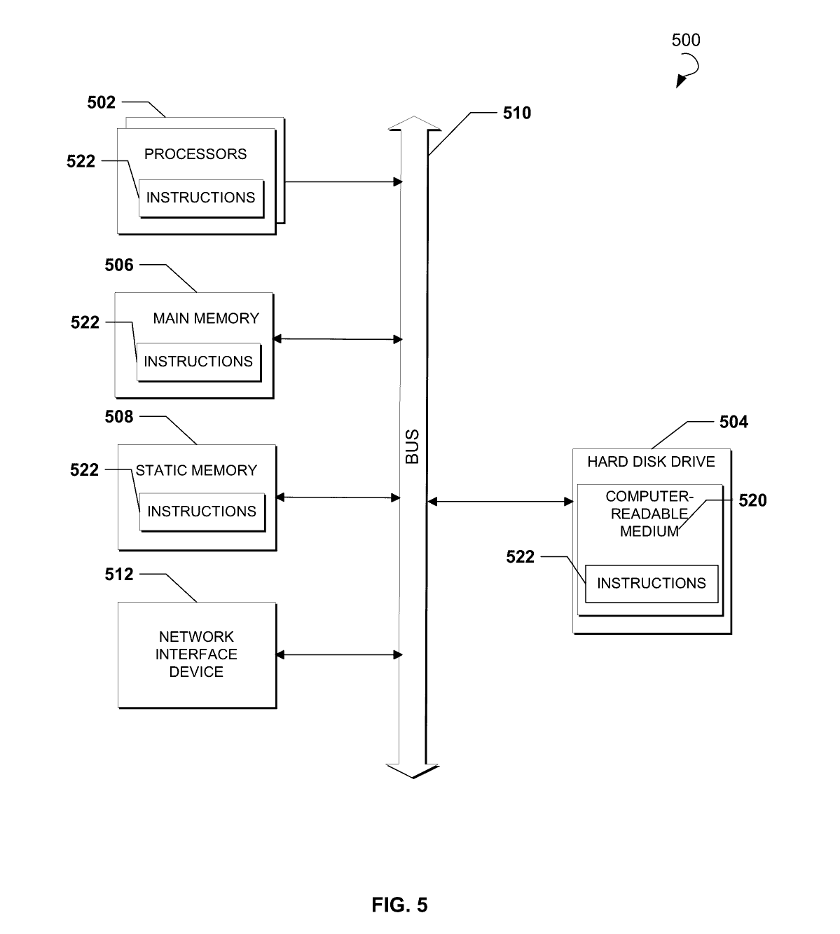

FIG. 5 shows a diagrammatic representation of a computing device for a machine in the exemplary electronic form of a computer system 500, within which a set of instructions for causing the machine to perform any one or more of the methodologies discussed herein can be executed. In various exemplary embodiments, the machine operates as a standalone device or can be connected (e.g., networked) to other machines. In a networked deployment, the machine can operate in the capacity of a server or a client machine in a server-client network environment, or as a peer machine in a peer-to-peer (or distributed) network environment. The machine can be a server, a personal computer (PC), a tablet PC, a set-top box, a cellular telephone, a digital camera, a portable music player (e.g., a portable hard drive audio device, such as an Moving Picture Experts Group Audio Layer 3 player), a web appliance, a network router, a switch, a bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 500 includes a processor or multiple processors 502, a hard disk drive 504, a main memory 506, and a static memory 508, which communicate with each other via a bus 510. The computer system 500 may also include a network interface device 512. The hard disk drive 504 may include a computer-readable medium 520, which stores one or more sets of instructions 522 embodying or utilized by any one or more of the methodologies or functions described herein. The instructions 522 can also reside, completely or at least partially, within the main memory 506 and/or within the processors 502 during execution thereof by the computer system 500. The main memory 506 and the processors 502 also constitute machine-readable media.

While the computer-readable medium 520 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media. Such media can also include, without limitation, hard disks, floppy disks, NAND or NOR flash memory, digital video disks, Random Access Memory, read-only memory, and the like.

The exemplary embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software programs for implementing the present method can be written in any number of suitable programming languages such as, for example, C, Python, JavaScript, Go, or other compilers, assemblers, interpreters or other computer languages or platforms.

Thus, systems and methods for determining a direction of a network session are described. Although embodiments have been described with reference to specific exemplary embodiments, it will be evident that various modifications and changes can be made to these exemplary embodiments without departing from the broader spirit and scope of the present application. Accordingly, the specification and drawings are to be regarded in an illustrative rather than a restrictive sense.

1. A system for determining a direction of a network session, the system comprising:
a network device operable to receive a data packet from a first device directed to a second device, the data packet being associated with the network session; and
an analyzing unit having one or more processors communicatively coupled to the network device, and a memory storing instructions which are executable by the one or more processors, the analyzing unit operable to:
analyze contextual data associated with the data packet, the contextual data indicating the data packet is a response to a previously sent data packet; and
based on the analysis, determine the direction of the network session is from the second device to the first device.

2. The system of claim 1, wherein the analyzing unit is further operable to:
determine that the data packet is not associated with a previous network session; and
based on the determination that the data packet is not associated with a previous network session, create a new network session using metadata associated with the data packet.

3. The system of claim 1, wherein the analyzing unit is further operable to:
determine that the data packet is associated with a previous network session; and
based on the determination that the data packet is associated with a previous network session, attribute the data packet to the previous network session.

4. The system of claim 1, wherein the determining of the direction includes determining a source and a destination of the data packet.

5. The system of claim 1, wherein the direction of the network session is between a client and a server.

6. The system of claim 1, wherein the contextual data includes payload data of the data packet.

7. The system of claim 1, wherein the contextual data includes header data of the data packet.

8. The system of claim 1, wherein the contextual data includes data associated with previous network sessions.

9. The system of claim 1, wherein the network device is further operable to direct the data packet according to the direction of the data packet.

10. A method for determining a direction of a network session, the method comprising:
receiving, by a network device having one or more processors, a data packet from a first device directed to a second device;
analyzing, by the network device, contextual data associated with the data packet, the contextual data indicating the data packet is a response to a previously sent data packet; and
based on the analysis, determining, by the network device, the direction of the network session is from the second device to the first device.

11. The method of claim 10, further comprising:
determining, by the network device, that the data packet is not associated with a previous network session; and
based on the determination that the data packet is not associated with a previous network session, creating a new network session using metadata associated with the data packet.

12. The method of claim 10, further comprising:
determining, by the network device, that the data packet is associated with a previous network session; and
based on the determination that the data packet is associated with a previous network session, attributing the data packet to the previous network session.

13. The method of claim 10, wherein the determining of the direction includes determining a source and a destination of the data packet.

14. The method of claim 10, wherein the direction of the network session is between a client and a server.

15. The method of claim 10, wherein the contextual data includes payload data of the data packet.

16. The method of claim 10, wherein the contextual data includes header data of the data packet.

17. The method of claim 10, wherein the contextual data includes data associated with previous network sessions.

18. The method of claim 10, further comprising directing, by the network device, the data packet according to the direction of the data packet.

19. The method of claim 10, further comprising alerting, based on the analysis, a network operator about a necessity to change network settings associated with the network device.

20. A system for determining a direction of a network session, the system comprising:
a communication module operable to receive a data packet from a first device directed to a second device; and
an analyzing module having one or more processors communicatively coupled to the communication module, and a memory storing instructions which are executable by the one or more processors, the analyzing module operable to:
analyze contextual data associated with the data packet, the contextual data including header data of the data packet, the contextual data indicating the data packet is a response to a previously sent data packet;
based on the analysis, determine the direction of the network session is from the second device to the first device;
based on the direction of the network session, determine that the data packet is associated with a previous network session; and
based on the determination that the data packet is associated with the previous network session, attribute the data packet to the previous network session.
